(19) United States
(12) Patent Application Publication
(10) Pub. No.: US 2026/0119379 A1
(43) Pub. Date: Apr. 30, 2026

(54) SYSTEMS AND METHODS FOR A SCALABLE AND COORDINATED ENTERPRISE TEST DATA MANAGEMENT SYSTEM

(71) Applicant: State Farm Mutual Automobile Insurance Company, Bloomington, IL (US)

(72) Inventors: Matthew Franklin, Le Roy, IL (US); Steven Beatty, Saybrook, IL (US); Brad Ross, Heyworth, IL (US)

(73) Assignee: State Farm Mutual Automobile Insurance Company, Bloomington, IL (US)

(21) Appl. No.: 18/933,450

(22) Filed: Oct. 31, 2024

(51) Int. Cl. G06F 11/36; G06F 21/62

(52) U.S. Cl. CPC G06F 11/3688; G06F 11/3676; G06F 21/6245

(57) ABSTRACT

Various embodiments of this disclosure relate generally to test data management. The method comprises: receiving, a request to execute a workflow from a device, wherein the request includes a data asset identifier corresponding to a data asset, a sensitive data subset, a sensitive data subset type, and a user identifier, generating, a data asset map corresponding to the data asset identifier, analyzing, the data asset and the data asset map to determine an optimized number of one or more portioned workflows for parallel processing, parsing, the data asset based on the optimized number of one or more portioned workflows of the workflow for parallel processing, executing, the one or more parsed workflows optimized for parallel processing, aggregating, the data from the one or more parsed workflows into an aggregated dataset, and transmitting, the aggregated dataset to a device corresponding to the user identifier.

### TECHNICAL FIELD

Various embodiments of this disclosure relate generally to techniques for test data management. In some embodiments, the disclosure relates to systems and methods for the generating of test data for test data management by optimizing the modification of the test data based on one or more workflows.

### BACKGROUND

Applications that use large datasets to provide recommendations, perform analysis, and/or otherwise process data for an end user are regularly re-developed and updated. Updating an application allows the application to continue to provide an accurate recommendation and/or analysis as the application's data is continuously collected. Once developed and deployed, an application may be updated throughout its lifecycle based on newly collected data. Many applications may include externally facing applications that are hosted on cloud-computing platforms. By hosting these applications on cloud-computing platforms, the security risk for data used in the development and testing of the applications is increased. Additionally, the data used to develop, test, and update these applications may include sensitive production data. The exposure of this sensitive production data may violate current and/or future privacy laws. However, to achieve the best result and highest quality applications, the data used in development, testing, and updating should be as realistic as possible. An organization may utilize a variety of tools to de-identify and/or generate synthetic datasets. However, no solution exists that integrates the data capture and the modification of such data to remove the sensitive data seamlessly across application testing environments. As a result, there is a need for improvements in test data management, specifically for improvements that may increase security by efficiently capturing, modifying, and generating test datasets that do not include sensitive data.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for test data management. More specifically, the disclosure may disclose methods and systems for generating test data for test data management by optimizing the modification of the test data based on one or more workflows.

In one aspect, an exemplary embodiment of a method for test data management is disclosed. The method may include receiving, by one or more processors, a request to execute a workflow from a device, wherein the request includes a data asset, a data asset identifier corresponding to a data asset, a sensitive data subset, a sensitive data subset type, and a user identifier. The method may further include, generating, by the one or more processors and a machine-learning model, a data asset map corresponding to the data asset identifier, wherein the data asset map identifies a location of the sensitive data subset and the corresponding sensitive data subset type within the data asset. The method may further include, analyzing, by the one or more processors, the data asset and the data asset map to determine an optimized number of one or more portioned workflows for parallel processing. The method may further include, parsing, by the one or more processors, the data asset based on the optimized number of one or more portioned workflows of the workflow for parallel processing. The method may further include, executing, by the one or more processors, the one or more parsed workflows optimized for parallel processing, wherein the executing includes obfuscating the sensitive data subset. The method may further include aggregating, by the one or more processors, the data from the one or more parsed workflows into an aggregated dataset. The method may further include transmitting, by the one or more processors, the aggregated dataset to a device corresponding to the user identifier.

In a further aspect, an exemplary embodiment of a computer system for test data management is disclosed. The computer system may include at least one memory storing instructions, one or more processors configured to access the memory and execute the processor-readable instructions, which when executed by the one or more processors configures the one or more processors to perform a plurality of functions. The functions may include receiving, by one or more processors, a request to execute a workflow from a device, wherein the request includes a data asset, a data asset identifier corresponding to a data asset, a sensitive data subset, a sensitive data subset type, and a user identifier. The functions may further include, generating, by the one or more processors and a machine-learning model, a data asset map corresponding to the data asset identifier, wherein the data asset map identifies a location of the sensitive data subset and the corresponding sensitive data subset type within the data asset. The functions may further include, analyzing, by the one or more processors, the data asset and the data asset map to determine an optimized number of one or more portioned workflows for parallel processing. The functions may further include, parsing, by the one or more processors, the data asset based on the optimized number of one or more portioned workflows of the workflow for parallel processing. The functions may further include, executing, by the one or more processors, the one or more parsed workflows optimized for parallel processing, wherein the executing includes obfuscating the sensitive data subset. The functions may further include aggregating, by the one or more processors, the data from the one or more parsed workflows into an aggregated dataset. The functions may further include transmitting, by the one or more processors, the aggregated dataset to a device corresponding to the user identifier.

In a further aspect, a non-transitory computer-readable medium containing instructions for test data management is disclosed. The instructions may include receiving, by one or more processors, a request to execute a workflow from a device, wherein the request includes a data asset, a data asset identifier corresponding to a data asset, a sensitive data subset, a sensitive data subset type, and a user identifier. The instructions may further include, generating, by the one or more processors and a machine-learning model, a data asset map corresponding to the data asset identifier, wherein the data asset map identifies a location of the sensitive data subset and the corresponding sensitive data subset type within the data asset. The instructions may further include, analyzing, by the one or more processors, the data asset and the data asset map to determine an optimized number of one or more portioned workflows for parallel processing. The instructions may further include, parsing, by the one or more processors, the data asset based on the optimized number of one or more portioned workflows of the workflow for parallel processing. The instructions may further include, executing, by the one or more processors, the one or more parsed workflows optimized for parallel processing, wherein the executing includes obfuscating the sensitive data subset. The instructions may further include aggregating, by the one or more processors, the data from the one or more parsed workflows into an aggregated dataset. The instructions may further include transmitting, by the one or more processors, the aggregated dataset to a device corresponding to the user identifier.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized with techniques presented herein, according to one or more embodiments.

FIG. 2 depicts an exemplary flowchart of an exemplary process for test data management, according to one or more embodiments.

FIG. 3 depicts an exemplary detailed flowchart of the exemplary process for test data management of FIG. 2, according to one or more embodiments.

FIG. 4A depicts an example flowchart of an exemplary process for executing one or more parsed workflows for test data management, according to one or more embodiments.

FIG. 4B depicts an example flowchart for queueing execution of one or more parsed workflows for test data management of FIG. 4A, according to one or more embodiments.

FIG. 5 depicts an example flowchart for an exemplary method for test data management, according to one or more embodiments.

FIG. 6 depicts an example of a computing device that may execute the techniques described herein, according to one or more embodiments.

### DETAILED DESCRIPTION OF EMBODIMENTS

According to certain aspects of the disclosure, methods and systems are disclosed for generating test data for test data management by optimizing the modification of the test data based on one or more workflows. In some embodiments, the disclosure relates to systems and methods for training a machine-learning based model to generate a data asset map for modifying a subset of sensitive data in a data asset, as well as determine an optimized number of portioned workflows for modifying the data asset.

Applications that use large datasets to provide recommendations, perform analysis, and/or otherwise process data for an end user are regularly re-developed and updated. Updating an application allows the application to continue to provide accurate recommendation and/or analysis as data is continuously collected. Once developed and deployed, the application may be updated throughout their lifecycle based on newly collected data. Many applications include externally facing applications that are hosted on cloud-computing platforms. By hosting these applications on cloud-computing platforms, the security risk for data used in the development and testing of the applications is increased. Additionally, the data used to develop, test, and update these applications may include sensitive production data. The exposure of this sensitive production data may violate current and/or future privacy laws. However, to achieve the best result and highest quality applications, the data used in development, testing, and updating should be as realistic as possible. An organization may utilize a variety of tools to de-identify and/or generate synthetic datasets. However, no solution exists that integrates data capture and the modification of such data to remove the sensitive data seamlessly across application testing environments (e.g., cloud-based, servers, mainframe, and/or other environments used for application development and/or testing). As a result, there is a need for improvements in test data management. These improvements may increase security by efficiently capturing, modifying, and generating test datasets that do not include sensitive data. Additionally, the system may optimize the modification of test data to seamlessly deliver test data to testing environments.

Such systems and methods include several advantages. First, the systems and methods may increase security and decrease the exposure risk of sensitive data for an organization. For example, the modification of data assets used in testing environments by obfuscating and/or de-identifying the sensitive data prevents sensitive data from being exposure to bad actors. Additionally, the system may optimize the processing of the modification of the test data to prevent long processing times by determining an optimized number of one or more portioned workflows. The one or more portioned workflows may be processed in parallel, increasing the efficiency of modifying the test data. Additionally or alternatively, the manual modification of the data may lead to increased inaccuracies. The inaccuracies may include sensitive data left in the data asset. Additionally or alternatively, the inaccuracies may include incorrectly modified data of the data asset, which may cause errors in the testing environment. These modified data assets and original data assets may have complex relationships across multiple databases and data store technologies. Consequently, the resulting test dataset should maintain all the original relationships and complexities, as well as a similar size to ensure the realism and functionality of the data used for integration testing in the testing environments.

As will be discussed in more detail below, in various embodiments, systems and methods are described for test data management. The method may include receiving, by one or more processors, a request to execute a workflow from a device, wherein the request includes a data asset, a data asset identifier corresponding to a data asset, a sensitive data subset, a sensitive data subset type, and a user identifier. The method may further include, generating, by the one or more processors and a machine-learning model, a data asset map corresponding to the data asset identifier, wherein the data asset map identifies a location of the sensitive data subset and the corresponding sensitive data subset type within the data asset. The method may further include, analyzing, by the one or more processors, the data asset and the data asset map to determine an optimized number of one or more portioned workflows for parallel processing. The method may further include, parsing, by the one or more processors, the data asset based on the optimized number of one or more portioned workflows of the workflow for parallel processing. The method may further include, executing, by the one or more processors, the one or more parsed workflows optimized for parallel processing, wherein the executing includes obfuscating the sensitive data subset. The method may further include aggregating, by the one or more processors, the data from the one or more parsed workflows into an aggregated dataset. The method may further include transmitting, by the one or more processors, the aggregated dataset to a device corresponding to the user identifier.

In a further aspect, an exemplary embodiment of a computer system for test data management is disclosed. The computer system may include at least one memory storing instructions, one or more processors configured to access the memory and execute the processor-readable instructions, which when executed by the one or more processors configures the one or more processors to perform a plurality of functions. The functions may include receiving, by one or more processors, a request to execute a workflow from a device, wherein the request includes a data asset, a data asset identifier corresponding to a data asset, a sensitive data subset, a sensitive data subset type, and a user identifier. The functions may further include, generating, by the one or more processors and a machine-learning model, a data asset map corresponding to the data asset identifier, wherein the data asset map identifies a location of the sensitive data subset and the corresponding sensitive data subset type within the data asset. The functions may further include, analyzing, by the one or more processors, the data asset and the data asset map to determine an optimized number of one or more portioned workflows for parallel processing. The functions may further include, parsing, by the one or more processors, the data asset based on the optimized number of one or more portioned workflows of the workflow for parallel processing. The functions may further include, executing, by the one or more processors, the one or more parsed workflows optimized for parallel processing, wherein the executing includes obfuscating the sensitive data subset. The functions may further include aggregating, by the one or more processors, the data from the one or more parsed workflows into an aggregated dataset. The functions may further include transmitting, by the one or more processors, the aggregated dataset to a device corresponding to the user identifier.

In a further aspect, a non-transitory computer-readable medium containing instructions for test data management is disclosed. The instructions may include receiving, by one or more processors, a request to execute a workflow from a device, wherein the request includes a data asset, a data asset identifier corresponding to a data asset, a sensitive data subset, a sensitive data subset type, and a user identifier. The instructions may further include, generating, by the one or more processors and a machine-learning model, a data asset map corresponding to the data asset identifier, wherein the data asset map identifies a location of the sensitive data subset and the corresponding sensitive data subset type within the data asset. The instructions may further include, analyzing, by the one or more processors, the data asset and the data asset map to determine an optimized number of one or more portioned workflows for parallel processing. The instructions may further include, parsing, by the one or more processors, the data asset based on the optimized number of one or more portioned workflows of the workflow for parallel processing. The instructions may further include, executing, by the one or more processors, the one or more parsed workflows optimized for parallel processing, wherein the executing includes obfuscating the sensitive data subset. The instructions may further include aggregating, by the one or more processors, the data from the one or more parsed workflows into an aggregated dataset. The instructions may further include transmitting, by the one or more processors, the aggregated dataset to a device corresponding to the user identifier.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for the existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal. ” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “model” or “machine-learning model” generally encompasses instructions, data, and/or a model configured to receive input, and apply one or more of a weight, bias, classification, or analysis on the input to generate an output (e.g., a video, a text-based output, or an audio output). The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

### Exemplary Environment

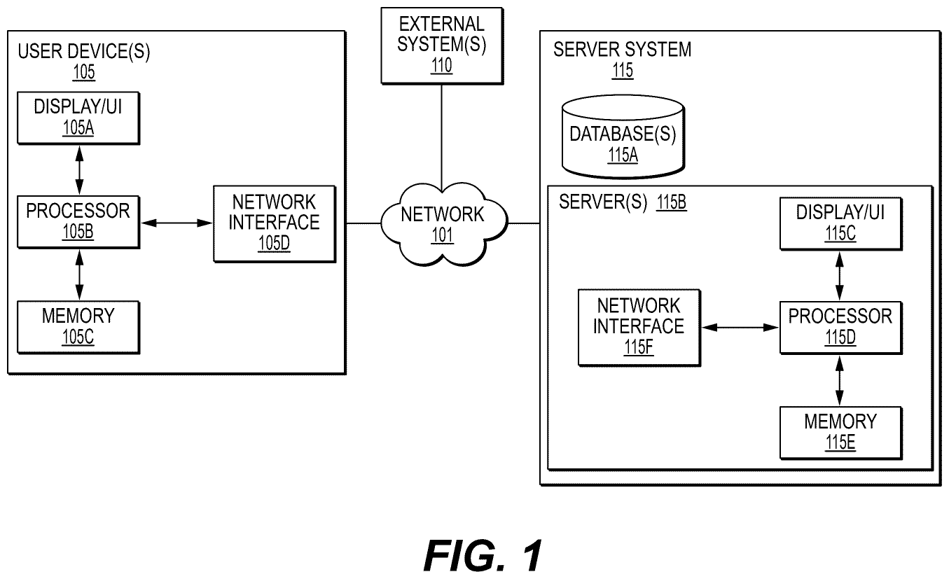

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user developing, editing, and/or utilizing a testing environment and/or application hosted on an external cloud-computing services that uses sensitive data, creating a potential exposure risk for environment 100.

In some embodiments, the components of the environment 100 are associated with a common entity. In some embodiments, one or more of the components of the environment is associated with a different entity than another. The systems and devices of the environment 100 may communicate in any arrangement.

As will be discussed herein, systems and/or devices of the environment 100 may communicate in order to generate, train, and/or use a machine-learning model for generating test data for test data management and/or optimizing the modification of the test data by determining an optimized number of portioned workflows.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115. For example, external systems 110 may include one or more cloud-computing platforms and/or services utilized by user device(s) 105 and/or server system 115 to host the application asset(s) and/or testing environments. In some embodiments, external systems 110 may include one or more machine-learning models and/or generative artificial intelligence (AI) used for the generation of test data for test data management and/or optimizing the modification of the test data by determining an optimized number of portioned workflows. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 415B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may be used for the generation of test data for test data management by optimizing the modification of the test data. For example, when developing, testing, and/or updating an application hosted on one or more external cloud-computing platforms, the modification of the test data may be based on whether the test data includes sensitive information, as well as on one or more workflows in the cloud environment. The server system 115 may include a machine-learning model and/or instructions associated with the machine-learning model, e.g., instructions for generating a machine-learning model, training the machine-learning model, using the machine-learning model, etc. The server system 115 may include data used by the one or more applications hosted on external system(s) 110 and/or for the generation of test data for test data management. The machine-learning model may generate a data asset map and/or determine an optimized number of one or more portioned workflows for executing the workflow and modifying the data more efficiently.

In some embodiments, a system or device other than the server system 115 may be used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to generate test data for test data management by generating a data asset map to modify the data asset according to the workflows. Additionally or alternatively, the training of the machine-learning model may cause the machine-learning model to analyze at least the data asset and data asset map to determine an optimized number of one or more portioned workflows.

In various embodiments, the variables of a machine-learning model may be interrelated in any suitable arrangement in order to generate the output. For example, in some embodiments, the machine-learning model may include signal processing architecture that is configured to identify, isolate, and/or extract features, patterns, and/or structure in a text. For example, the machine-learning model may include one or more convolutional neural network (“CNN”) configured to identify features in the document information data, and may include further architecture, e.g., a connected layer, neural network, etc., configured to detect an change indicator in the data source of an application asset and/or whether the change indicator is a material or non-material change.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized for generation of test data for test data management by optimizing modification of test data based on one or more workflows are discussed in further detail in the methods above. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

In general, any process or operation discussed in this disclosure that is understood to be computer-implementable, such as the processes illustrated, may be performed by one or more processors of a computer system, such any of the systems or devices in the environment 100 of FIG. 1, as described above. A process or process step performed by one or more processors may also be referred to as an operation.

The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Process for Test Data Management

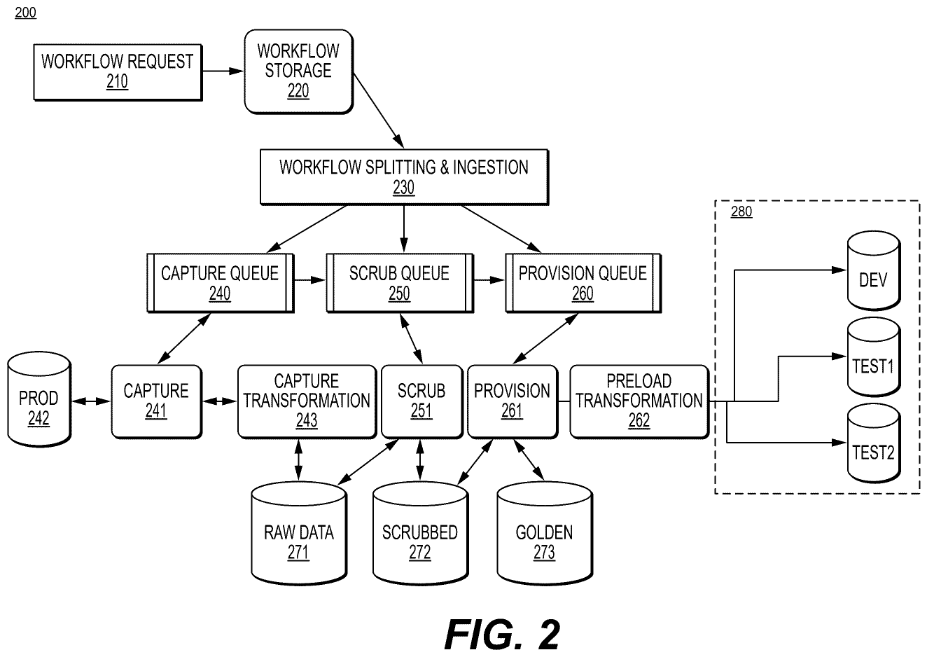

FIG. 2 depicts a flowchart of an exemplary process 200 for test data management by optimizing the modification of test data based on one or more workflows, according to one or more embodiments. Process 200 may be performed by one or more processors of a server that is in communication with one or more mobile devices and other external system(s) via a network. However, it should be noted that process 200 may be performed by any one or more of the server, one or more user devices, or other external systems. In some embodiments, each service described below (e.g., capture, modify, provision) and/or the sub-components of the services may be containerized. The containerized services may be individually executed anywhere they are assigned in a cloud-based environment. This may allow the process 200 to more efficiently use computer resources.

The process 200 may include receiving, by one or more processors (e.g., processor 105B, processor 115D), a request to execute a workflow from a device (Block 210). The workflow may define a process for modifying a data asset, such that the system may use the data asset as test data for the development and the testing of an application. In response to receiving the request, the one or more processors may retrieve the workflow that defines a process for modifying a data asset from a data store (e.g., database(s) 115A) (Block 220). The data asset may include data collected from an organization, users of an application, and/or other data relevant for an end application. The data asset may include data relevant to developing, updating, and/or testing an application. The data of the data asset may include sensitive information that, if used to develop, update, and/or test an application, may pose a security risk.

In some embodiments, one or more user device(s) 105 may transmit one or more workflows that define a process for modifying a data asset for test data management to a server system (e.g., server system 115). The one or more workflows may be defined in a prompt (e.g., a JSON prompt) and/or through a user application programming interface (API). The workflow, via the prompt and/or API, may indicate a data asset, modifications to the data within the data asset, and/or one or more target destination(s) for the modified data asset.

For example, a prompt may define the use of the capture service, modify service, and/or provision service, as described in more detail below. The prompt may include an overview of the workflow, the identities of the user devices, a related or parent workflow (if applicable), and/or which services may be used. The prompt may also include a section defining the use of each service.

For example, the capture section may include a data asset identifier, the storage location of the data asset, data type, and/or a location for raw data storage. The data type may indicate the format of the data (e.g., structured data (relational data)), semi-structured data (JSON and/o XML data), and/or unstructured data (character and binary data). The service section may include the data asset identifier, the storage location of the data asset, the data type, and/or a sensitive data subset type. In some embodiments, the service section may also identify a key corresponding to the sensitive data subset type, which may be used to generate a data asset map. The provision section may similarly include the data asset identifier, the storage location of the data asset, the data type, and/or a location for the golden copy of the modified data, as well as one or more target destinations. The target destination(s) may include storage devices (e.g., a database), a user device corresponding to the user identifier in the prompt and/or request.

In some embodiments, the prompt may include instructions for the initial aggregation of data from one or more data assets in a stored database. This may allow the system to execute the one or more workflows at a later date. For example, for certain data types, the capture section may define an instruction to initially aggregate and store the data in a database. The prompt may then define a database function that allows the database to return the stored data for execution of the modify section and/or provision section of the one or more workflows included in the prompt. This may enable the data to be captured, modified, and provisioned together in real-time or separately scheduled based on the prompt.

The system may receive the prompt from the user device(s) 105. After receiving the prompt, the system may store the one or more workflows defined in the prompt in a database (e.g., database(s) 115A, memory 105C). The system may retrieve the one or more workflows from storage and execute the one or more workflows.

In some embodiments, the request and/or prompt may include a data asset identifier corresponding to a data asset, a sensitive data subset, a sensitive data subset type, and/or a user identifier. In some embodiments, the modification of the data asset may include de-identifying subsets of data within the data asset that have a certain sensitive data type. The data asset may include personally identifiable information (PII), sensitive personal information (SPI), personal health information (PHI), and/or similar types of sensitive data.

In some embodiments, the sensitive data may include customer data collected by an organization. For example, the data asset may include the date(s) of birth (DOBs), social security number(s) (SSN), vehicle identification number(s) (VINs), driver's license number(s) (DLNs), and/or other customer data that may be collected during an organization's operations. This data may be integral in the development, updating, and testing of applications of an organization. Application development, updating, and testing may be hosted in external environments and/or cloud-computing platforms external to the organization. As such, the use of this data with sensitive information may pose a security risk. To increase data security, the sensitive data within the data asset should be modified (e.g., obfuscated, de-identified, scrubbed) to prevent the exposure of sensitive data in the event of a data breach and/or during development, updating, and/or testing of the applications.

The process 200 may include ingesting and splitting the one or more workflows (Block 230). In some embodiments, the one or more workflows may be executed in parallel to each other. The one or more workflows may be executed in three stages, a capture queue (Block 240), a modification queue (Block 250), and/or a provision queue (Block 260). The capture queue may identify the data asset and prepare the data asset for the modification of the data asset. The capture queue may queue workflows for the operations of the capture services, which may execute the capture portion of the workflow. For example, the system may capture the raw data asset and then generate the data asset map. The modification queue may modify the data asset according to the corresponding workflow. The modification queue may queue one or more workflows for operations of the modify services, which may execute the modification portion of the workflow. For example, the system may receive the raw data asset and data asset map from the capture queue and/or raw data cache, where the system may modify the raw data asset according to the workflow and data asset map. The provision queue may store the modified data asset and transmit the modified data asset to the target destination(s).

In some embodiments, the capture queue may access the queued workflow for data capture. The capture service may capture data asset according to the data asset identifier included in the request and/or prompt. The request and/or prompt may also include a data asset location. For example, the request and/or prompt may identify a data asset that may be modified according to the workflows. The prompt and/or request may include a data asset identifier and/or a location of the data asset, which indicates where the data asset may be captured. The system may store a copy of the data asset in the raw data cache. This may allow the data asset to be captured appropriately for modification in the modification queue (Block 250).

In some embodiments, the data asset may be modified (e.g., data added or removed and/or storage location changed) between the time the prompt is received and the request is received. For example, at a first time period, the prompt may define one or more workflows by identifying a data asset, as well as a modification of the data. For example, the modification may utilize the capture, modify, and/or provision service(s). The system may store the prompt for execution at a later date. For example, an application development and/or testing team may preemptively define a workflow for modifying a data asset which includes the concurrent collection of data. The sensitive data type and modification may already be known, but the dataset may not be complete. Therefore, the workflow may be preemptively defined in the prompt and saved for execution when the data collection in the data asset is complete. The request for execution of the one or more workflows identified in the prompt may be received at a second time. In some embodiments, the first time and the second time be simultaneous. Additionally or alternatively, the second time may be received minutes, hours, days, weeks, months, and/or years after the first time. As a result, the data asset may have changed in contents and/or location. Therefore, the request may update the data asset identifier and/or location of the data asset previously included in the prompt.

The one or more processors may retrieve the data asset from the storage location based on the data asset identifier and location (Block 242). The system may capture the data, so that the data can be modified without modifying the original data asset (Block 241). The system may store the captured data in the raw data cache. Additionally or alternatively, the system may store the unmodified data in a different data structure or format than the original data asset. The system may convert the data into another format (e.g., data files) for modification. This may allow the system to efficiently execute the one or more workflows in parallel with smaller, parsed amounts of data.

In some embodiments, the process 200 may include a capture transformation, which may increase the efficiency of the modification of the data asset (Block 243). The capture transformation process may include generating a data asset map for the data asset. The data asset map may identify a location of a sensitive data subset within the data asset. The sensitive data subset may correspond to the sensitive data type identified in the prompt and/or request.

In some embodiments, a machine-learning model may generate the data asset map. For example, a data asset may include unstructured data stored in a cloud storage platform. The machine-learning model may receive the unstructured data and the sensitive data type as input. The machine-learning model may be configured to process the unstructured data and create a data asset map based on the sensitive data type.

In some embodiments, the data asset map may identify one or more data types. To effectively obfuscate the data, as discussed below, the sensitive data may be replaced by a null value that still represents the sensitive data type. This may allow the modified data asset to replicate realistic data. Additionally or alternatively, the obfuscated data may be of approximately the same size as the sensitive data, such that the size of the modified data asset is comparable to the original data asset. This may simulate real-world conditions for the testing environment.

The process 200 may include storing the raw data (e.g., unmodified data of the data asset) and the data asset map in the raw data cache (Raw Data Cache 271). The raw data may be stored for a period of time after the data asset has been modified, according to the one or more workflows.

The process 200 may include a modify stage (Block 251). In some embodiments, the modification queue may modify the data asset according to the one or more workflows and data asset map. The modification queue may access the queued workflow for modification from the capture queue. The modify service may access the captured data asset and the data asset map from a raw data cache (Block 271) (e.g., database(s) 115A). The system may then modify the data asset as specified in the one or more workflows. For example, the system may modify the data asset at the locations specified in the data asset map.

For example, the one or more workflows may define a process for modifying the data asset using the capture service and modify service, where the process may include obfuscating personal identifying information (PII) and replacing the PII with one or more null values. The modify service may include a function to generate a null value that is an appropriate replacement for the sensitive data. In some embodiments, the system may use a script to generate null values based on the data type, data asset, and/or additional information related to the one or more workflows (e.g., user identifier, target destination(s), and/or other related information). Additionally or alternatively, the null values may be generated using a machine-learning model and/or the one or more workflows may indicate specific null values that correspond to individual sensitive data types. For example, a date of birth may be replaced with text and/or numbers that the target destination application recognizes as a null value. The data asset map may indicate the locations of the PII within the data asset. During modification, the one or more processors may use the data asset map and one or more workflows to modify the data asset accordingly.

In some embodiments, the modified data may be stored in a modified data cache (e.g., database(s) 115A) (Modified Data Cache 272). Depending on the workflow and/or target destination(s), the modified data may be stored in a modified data cache 272 temporarily or permanently. The system may transmit the modified data stored at modified data cache 272 to the target destination(s) (Block 280). For example, the modified data may be transmitted to target destinations including storage devices (e.g., database(s) 115A), a user device corresponding to the user identifier (e.g., user device(s) 105), and/or directly to a testing environment (e.g., external system 110).

The process 200 may include a provision stage (Block 261). The provision stage may include transmitting the modified data asset to the one or more target destinations, as discussed in the previous paragraphs. For example, the workflows may include instructions for transmitting the modified data asset to one or more data stores (e.g., database(s) 115A) and/or one or more user devices associated with the user identifier (e.g., user device(s) 105). In some embodiments, the modified data asset may include an aggregated dataset. The aggregated dataset may include the aggregated data from each of the one or more portioned workflows after being modified by the modification service 326. The one or more portioned workflows may include sub-workflows, which may include the system parsing and portioning the data asset into one or more smaller datasets. The one or more portioned workflows may execute the same modification defined in the workflow of the prompt/request for each of the parsed and portioned datasets. In some embodiments, the one or more portioned workflows may be processed in parallel to increase the efficiency of executing the workflow and the corresponding computer resources.

In some embodiments, the one or more processors may preload the modified data asset before transmitting the modified data asset to the target destination(s) (Block 262). In some embodiments, the data structure of the data asset may be altered during the capture process (Block 241 and/or Block 243) for modifying the data asset (Block 251). For example, the data of the data asset may be stored in a different format than the original data asset (e.g., data files) for modification. The preload transformation service may convert the modified data into a data format compatible with the target destination (Block 262). The modified data, converted to a compatible data format for the target destination(s), may be transmitted to one or more data stores (e.g., database(s) 115A) and/or one or more user devices associated with the user identifier (e.g., user device(s) 105).

In some embodiments, the one or more processors may store a golden copy of the modified data in a data store (e.g., database(s) 115A) (Golden Copy Data Cache 273). The system may store the golden copy in long term or permanent storage. This may create a back-up for the data after being transmitted to the target destination(s). The golden copy may be preserved if the data is corrupted, damaged, and/or needs to be verified against a golden copy during use in the testing environment. Additionally, the system may execute the one or more workflows repeatedly as data may be added to the data asset and/or the test environment iterates through the testing process.

The storage of a golden copy of the modified data may allow the one or more processors to efficiently execute repetitions of the one or more workflows. For example, data may have been added to the data asset. The golden copy of the modified data stored at golden copy data cache 273, the raw data stored at the raw data cache 271, and/or the data asset may be compared to each other to determine that only a subset of the data asset has not been modified. The one or more processors may perform the process 200 on the unmodified portions of the data asset according to the one or more workflows.

The system may transmit the golden copy of the modified data asset to golden copy data cache 273 and a working copy of the modified data asset to the target destination(s). Preserving the golden copy may prevent duplicating the processing and increase the efficiency of the computer resources if the working copy is corrupted, damaged, and/or needs to be verified against a golden copy. Additionally or alternatively, more data may be collected and added to the data asset. The golden copy of the modified data asset may be used to determine which subset of data within the data asset has previously been modified (e.g., stored in golden copy data cache 273) and which is newly collected unmodified data. This may increase the efficiency in the use of computer resources, by not re-processing data that has previously been modified.

Although FIG. 2 shows example blocks of exemplary process 200, in some implementations, the exemplary process 200 may include additional blocks, fewer blocks, different blocks, or differently arranged blocks than those depicted in FIG. 2.

Additionally, or alternatively, two or more of the blocks of the exemplary process 200 may be performed in parallel.

### Exemplary Process for Generating Test Data for Test Data Management

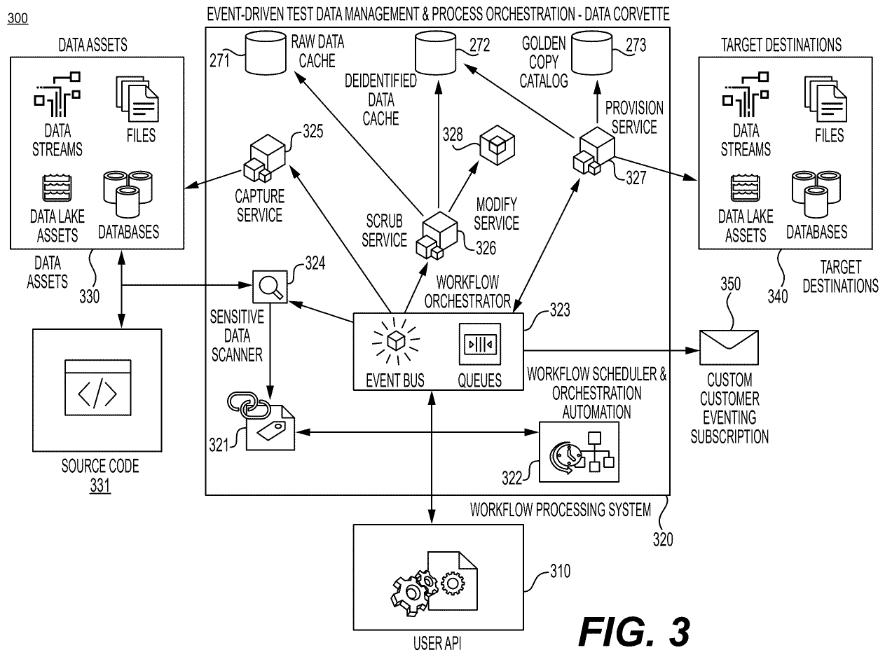

FIG. 3 depicts a flowchart of an exemplary process 300 for the generation of test data for test data management by optimizing the modification of the test data based on one or more workflows, according to one or more embodiments.

The process 300 may be performed by one or more processors of a server that is in communication with one or more mobile devices and other external system(s) via a network. However, it should be noted that the process 300 may be performed by any one or more of the server, one or more user devices, or other external systems. In some embodiments, each service described below (e.g., capture service, modify service, provision service) and/or the sub-components of the services may be containerized. The containerized services may be individually executed anywhere they are assigned in a cloud based environment. This may allow the process 300 to more efficiently use computer resources.

The process 300 may include receiving, at a workflow processing system 320 (e.g., server system 115), one or more workflows from one or more user device(s) 105. The one or more workflows may define a process for generating test data by modifying a data asset. The modification may include de-identifying the data asset (e.g., data asset(s) 330) to remove a sensitive data subset within the data asset. The one or more workflows may be defined in a prompt (e.g., a JSON prompt) and/or through a user application programming interface (API) (e.g., User API 310).

The workflow processing system 320 may store the prompt in a data store (e.g., database(s) 115) until a request may be received. The workflow scheduler & orchestration automation 322 may store the prompt and/or the workflows. In some embodiments, the workflow scheduler & orchestration automation 322 may store the prompt and/or one or more workflows for a period of time (e.g., hours, weeks, months, and/or years) until the user device(s) 105 transmit a request to the system to execute the one or more workflows.

In some embodiments, the prompt may include multiple workflows that are intended to be executed in succession. For example, the completion of a first workflow may trigger the execution of a second workflow. This may optimize generation and modification of test data in complex data storage systems, where one or more data stores may have data that depends on, or from, data stored in another location. A first data asset may be modified prior to a second data asset in order to maintain the integrity of the modified data asset. The workflow scheduler & orchestration automation 322 may increase the efficiency of the generation and modification of test data management by optimizing the execution of successive workflows.

In some embodiments, in order to execute the one or more workflows, the workflow orchestrator 323 may receive a request. After receiving a request to execute the workflows, the workflow orchestrator 323 may retrieve the workflows from storage and execute the workflows. For example, the workflow orchestrator 323 may receive a request that includes a data asset identifier corresponding to a data asset, a sensitive data subset, a sensitive data subset type, and/or a user identifier.

The data asset may include data stored in one or more location on premise systems and/or off-premise systems (e.g., data streams, data files, databases, and/or data lake assets). In some embodiments, the request and/or prompt may include a data asset identifier that corresponds to a data asset, a sensitive data subset, a sensitive data subset type, and/or a user identifier. In some embodiments, the modification of the data asset may include de-identifying subsets of data within the data asset having a certain sensitive data type. The data asset may include personally identifiable information (PII), sensitive personal information (SPI), and personal health information (PHI) and/or similar types of sensitive data.

In some embodiments, the sensitive data may include customer data collected by an organization. For example, the data asset may include the date(s) of birth (DOBs), social security number(s) (SSN), vehicle identification number(s) (VINs), driver's license number(s) (DLNs), and/or other customer data that may be collected during an organization's operations. This data may be integral in the development, updating, and testing of applications of an organization. Application development, updating, and testing may be hosted in external environments and/or cloud-computing platforms external to the organization. As such, the use of this data with sensitive information may pose a security risk. To increase data security, the sensitive data within the data asset should be modified (e.g., obfuscated, de-identified, scrubbed) to prevent the exposure of sensitive data in the event of a data breach and/or during the development, updating, and/or testing of the applications.

In some embodiments, the asset relationship & metadata store 321 may update the data asset identifier, location of the data asset, and/or any additional metadata related to the data asset. The metadata of the data asset may be updated based on differences between the prompt and request for the same workflows.

In some embodiments, the data asset(s) 330 may be modified (e.g., data added or removed and/or storage location change) between the time the prompt is received and the request is received. For example, at a first time period, the prompt may define one or more workflows by identifying a data asset, as well as a modification of the data. For example, the modification may utilize the capture, modify, and/or provision service(s). The system may store the prompt for execution at a later date.

For example, an application development and/or testing team may preemptively define a workflow for modifying a data asset which includes the concurrent collection of data. The sensitive data type and modification may already be known, but the dataset may not be complete. Therefore, the workflow may be preemptively defined in the prompt and saved for execution when the data collection in the data asset is complete. The request for execution of the one or more workflows identified in the prompt may be received at a second time. In some embodiments, the first time and the second time be simultaneous. Additionally or alternatively, the second time may be received minutes, hours, days, weeks, months, and/or years after the first time. As a result, the data asset may have changed in contents and/or location. Therefore, the request may update the data asset identifier and/or location of the data asset previously included in the prompt.

The request for execution of the one or more workflows identified in the prompt may be received at a second time. In some embodiments, the first time and the second time may be simultaneous. For example, the prompt and request may be received by the workflow processing system 320 at the same time. Additionally or alternatively, the second time may be received minutes, hours, days, weeks, months, and/or years after the first time. As a result, the data asset may have changed in contents and/or location. Therefore, the request may update the data asset identifier and/or location of the data asset previously included in the prompt.

In some embodiments, the user device(s) 105 and/or user identifier associated with the prompt and/or request may be authenticated. For example, a JSON web token (JWT) may be generated via a user API 310. A request may be submitted from the user device(s) 105 over the user API 310 to the system, and in response to the request, the workflow processing system 320 (e.g., server system 115) and/or external systems 110 may authenticate the token and the user device(s) 105. In response to authentication, the prompt and/or request may be transmitted to the workflow orchestrator 323.

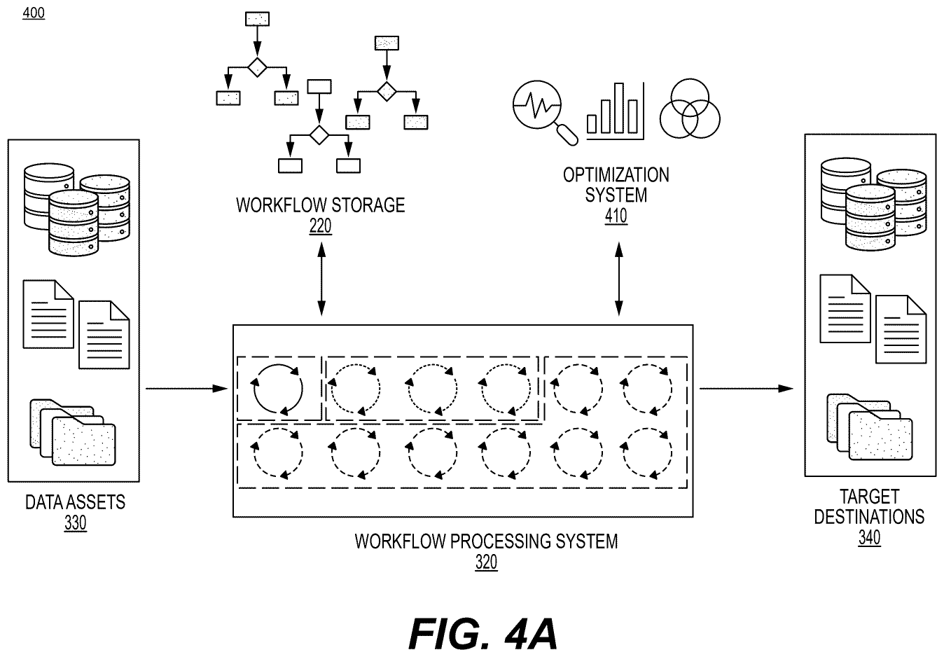

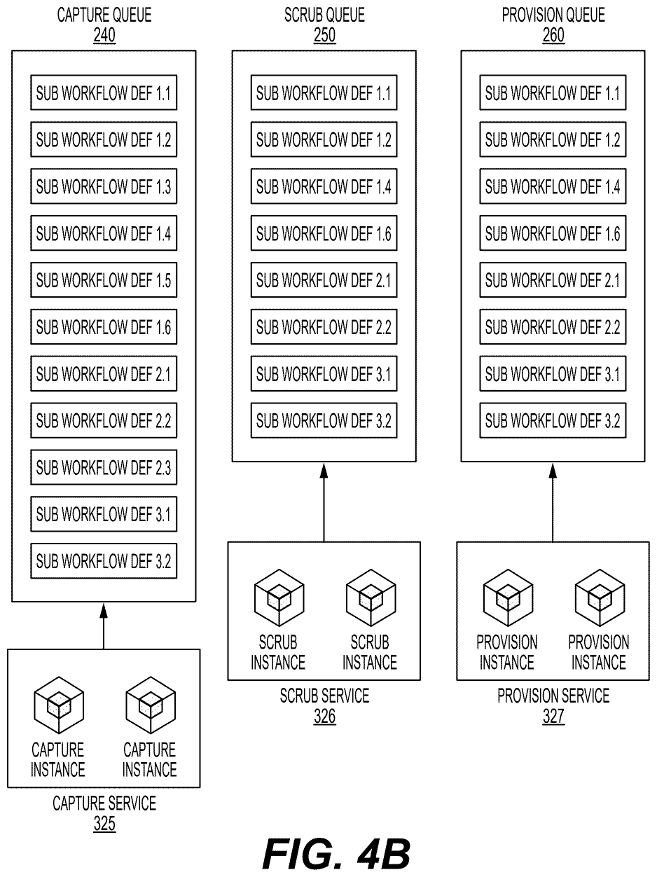

In some embodiments, and as further described with respect to FIGS. 4A-4B, the workflow orchestrator 323 may utilize the sensitive data scanner 324 to determine an optimized number of one or more portioned workflows for parallel processing in the capture service 325, the modify service 326, and/or the provision service 327. For example, the sensitive data scanner 324 may analyze the data asset identifier, sensitive data type, sensitive data subset, location of the data asset, and/or the size of the data asset to determine the optimized number of one or more portioned workflows for parallel processing. In some embodiments, the sensitive data scanner 324 may use source code 331 (e.g., application and infrastructure source code from the application the modified data will be used in) to identify sensitive data of the data asset 330. In some embodiments, the workflow processing system 320 may use the source code 331 to generate the sensitive data map. For example, the source code (or a portion of the source code) may be used as an input in the machine-learning model to generate the data asset map. The use of the source code 331 may allow the system to better identify sensitive data types in the data asset by understanding the use of the data in the application

As discussed with reference to FIG. 2, the one or more workflows may be executed in three stages by the capture service 325, the modify service 356, and/or the provision service 327. The capture service 325 may identify the data asset(s) 330 and prepare the data asset and system for modification of the data asset. The modify service 326 may modify the data asset(s) 330 according to the corresponding workflow(s). The provision service 327 may store the modified data asset in one or more databases and transmit the modified data asset to the target destination(s) 340.

In some embodiments, the capture service 325 may access the data asset based on the data asset identifier included in the request and/or prompt. The capture service 325 may capture the data asset 330 according to the data asset identifier included in the request and/or prompt. The request and/or prompt may also include a data asset location. For example, the request and/or prompt may identify a data asset 330 that may be modified according to the workflows. The prompt and/or request may include a data asset identifier and/or a location of the data asset, which indicates where the data asset may be captured. The system may store a copy of the data asset in the raw data cache. This may allow the data asset to be captured appropriately for modification by the modify service 326.

The one or more processors may retrieve the data asset from the storage location (e.g., database) based on the data asset identifier and location. The system may capture the data so that the data can be modified without modifying the data asset 330 in its storage location. In some embodiments, the capture service 325 may capture one or more portions of the data asset 330 corresponding to the optimized one or more portioned workflows.

In some embodiments, a machine-learning model may generate the data asset map. For example, a data asset may include unstructured data stored in a cloud storage platform. The machine-learning model may receive the unstructured data and the sensitive data type as input. The machine-learning model may be configured to process the unstructured data and create a data asset map based on the sensitive data type. In some embodiments, the capture service 325 may generate a data asset map for each of the one or more portions of data asset 330.

In some embodiments, the data asset map may identify one or more data types. To effectively obfuscate the data, as discussed below, the sensitive data may be replaced by a null value that still represents the sensitive data type. This may allow the modified data asset to replicate realistic data. Additionally or alternatively, the obfuscated data may be of approximately the same size as the sensitive data, such that the size of the modified data asset is comparable to the original data asset. This may simulate real-world conditions for the testing environment

The process 300 may include storing the raw data (e.g., unmodified data of the data asset) and the data asset map in a raw data cache 271 (e.g., database(s) 115A). In some embodiments, the raw data cache 271 may store individual portions of data asset 330. Additionally or alternatively, the raw data cache 271 may aggregate the portions of the data asset 330. The raw data may be stored for the duration of process 300. Additionally or alternatively, the raw data may be stored for a period of time after the data asset has been modified. The raw data cache 271 may pass the capture data asset(s) and/or data asset map(s) to a modification service 326.

The modification service 326 may modify the data asset according to the one or more workflows and data asset map. In some embodiments, the modification service 326 may receive one or more portioned workflows from the workflow orchestrator 326. The captured data asset(s) and the data asset map(s) may be accessed from the raw data cache 271 (e.g., database(s) 115A).

The system may modify the data asset as specified by the one or more workflows and/or one or more portioned workflows at the locations specified in the data asset map. For example, the one or more workflows may define a process for modifying the data asset using the capture service and modify service, where the process may include obfuscating personal identifying information (PII) and replacing the PII with one or more null values. The modify service may include a function to generate a null value that is an appropriate replacement for the sensitive data. Additionally or alternatively, the one or more workflows may indicate specific null values that correspond to individual sensitive data types. For example, a date of birth may be replaced with text and/or numbers that the target destination application recognizes as a null value. The data asset map may indicate the locations of the PII within the data asset. During modification, the one or more processors may use the data asset map and one or more workflows to modify the data asset accordingly.

For example, a date of birth may be replaced with text and/or numbers that the target destination application recognizes as a null value. The data asset map may indicate the locations of the PII within the data asset. During modification, the one or more processor may use the data asset map and one or more workflows to modify the data asset accordingly.

In some embodiments, the modified data cache 272 (e.g., database(s) 115A) may store the modified data. The provision service 327 may transmit the modified data stored in the modified data cache 272 to the target destinations.

The provision service 327 may access the modified data asset(s) from the modified data cache 272. In some embodiments, the provision service 327 may aggregate the one or more portions of the modified data asset. The provision service 327 may receive the portioned workflows from the workflow orchestrator 323 to determine which portions of the modified data asset should be aggregated.

In some embodiments, the provision service 327 may transmit the modified data asset to one or more target destinations 340 specified in the workflows.

For example, the workflows may include instructions to transmit the modified data asset to one or more data stores (e.g., database(s) 115A) and/or user device(s) 105. In some embodiments, the target destination(s) may include data streams, data files, database(s), and or data lake assets that are accessible by the testing environment.

In some embodiments, the one or more processors may store a golden copy of the modified data in a data store (e.g., database(s) 115A) (Golden Copy Data Cache 273). The system may store the golden copy in long term or permanent storage. This may create a back-up for the data after being transmitted to the target destination(s). The golden copy is preserved if the data is corrupted, damaged, and/or needs to be verified against a golden copy during use in the testing environment. Additionally, the system may execute the one or more workflows repeatedly as data may be added to the data asset and/or the test environment iterates through the testing process.

The storage of a golden copy of the modified data may allow the one or more processors to efficiently execute repetitions of the one or more workflows. For example, data may have been added to the data asset. The golden copy of the modified data stored at golden copy data cache 273, the raw data stored at the raw data cache 271, and/or the data asset may be compared to each other to determine that only a subset of the data asset has not been modified. The one or more processors may perform the process 200 on the unmodified portions of the data asset according to the one or more workflows.

The system may transmit the golden copy of the modified data asset to golden copy data cache 273 and a working copy of the modified data asset to the target destination(s). Preserving the golden copy may prevent duplicating the processing and increase the efficiency of the computer resources if the working copy is corrupted, damaged, and/or needs to be verified against a golden copy. Additionally or alternatively, more data may be collected and added to the data asset. The golden copy of the modified data asset may be used to determine which subset of data within the data asset has previously been modified (e.g., stored in golden copy data cache 273) and which is newly collected, unmodified data. This may increase the efficiency in the use of computer resources, by not re-processing data that has previously been modified.

In some embodiments, the workflow orchestrator 323 may generate and transmit a custom customer eventing subscription 350. The custom customer eventing subscription may be transmitted to user device(s) associated with the user identifier in the prompt and/or request. In some embodiments, custom customer eventing description 350 may provide updates on the execution of the one or more workflows of the prompt and/or request. Additionally or alternatively, the custom customer eventing subscription 350 may be transmitted in conjunction with the provision service 327 and/or for the execution of each service (e.g., capture service 325, modify service 326, and/or provision service 327).

Although FIG. 3 shows example blocks of exemplary process 300, in some implementations, the exemplary process 300 may include additional blocks, fewer blocks, different blocks, or differently arranged blocks than those depicted in FIG. 3.

Additionally, or alternatively, two or more of the blocks of the exemplary process 300 may be performed in parallel.

### Exemplary Method for Determining an Optimized Number of Portioned Workflows

FIGS. 4A and 4B depict a flowchart of an exemplary process 400 for optimizing the modification of test data based on one or more workflows, according to one or more embodiments. The process 400 may be performed by one or more processors of a server that is in communication with one or more user devices and other external system(s) via a network. However, it should be noted that process 400 may be performed by any one or more of the server, one or more user devices, or other external systems.

The process 400 may include the workflow processing system 320 analyzing the data asset 330 and one or more data asset maps to determine an optimized number of portioned workflows for parallel processing. In some embodiments, the workflow orchestrator 232 may use the sensitive data scanner 324 to determine an optimized number of portioned workflows for parallel processing in the capture service 325, the modify service 326, and/or the provision service 327. In some embodiments, the system may parse the data asset 330 according to one or more portioned workflows. The one or more portioned workflows may be processed in parallel at manageable data sizes.

In some embodiments, the workflow processing system 320 may process multiple workflows corresponding to individual prompts and/or requests. The system may analyze each data asset 330 associated with the one or more workflows to determine the optimized number of portioned workflows. As shown in FIGS. 4A and 4B, some data assets may have a size that may execute as a single workflow. The data asset may be portioned based on size, sensitive data type, complexity of the modifications, and/or additional metrics associated with the data asset, workflow, and/or the workflow processing system 320. For example, the optimized number of one or more portioned workflows may depend on the existing computer resources at the time of analysis.

In some embodiments, the workflow processing system 320 may use a machine-learning model (optimization system 410) to determine the optimized number of portioned workflows. The data asset, the data asset map, the size of the data asset, and/or the one or more workflows may be input into a machine-learning model configured to determine an optimized number of portioned workflows. The machine-learning model may provide a recommendation for the optimized number of one or more portioned workflows, (e.g., portioning the processing of the workflow into sub-workflows). In some embodiments, the optimization system may use data related to the processing time, the accuracy, the processing resources of the workflow processing system 320, and/or the workflow execution to re-train the machine-learning model(s) of the optimization system 410.

As shown in FIG. 4B, the system may execute the one or more portioned workflows in parallel by the capture service 325, the modify service 326, and/or the provision service 327. The one or more portioned workflows associated with the same prompt and/or request may queue in the capture queue 240, the modify queue 250, and/or the provision queue 260 until the workflow is available to be processed in parallel at one time.

The capture instance(s), the modify instance(s), and/or the provision instance(s) may store the data from the one or more portioned workflows at each stage. The system may pass the instances from the capture service 325 to the modify service 326 and/or to the provision service 327. The provision service 327 may aggregate the instances into a single complete dataset, which may be transmitted to the target destination(s) 280 and/or 340.

Although FIGS. 4A and 4B show example blocks of exemplary process 400, in some implementations, the exemplary process 400 may include additional blocks, fewer blocks, different blocks, or differently arranged blocks than those depicted in FIGS. 4A-4B. Additionally, or alternatively, two or more of the blocks of the exemplary process 400 may be performed in parallel.

### Exemplary Method for Test Data Management

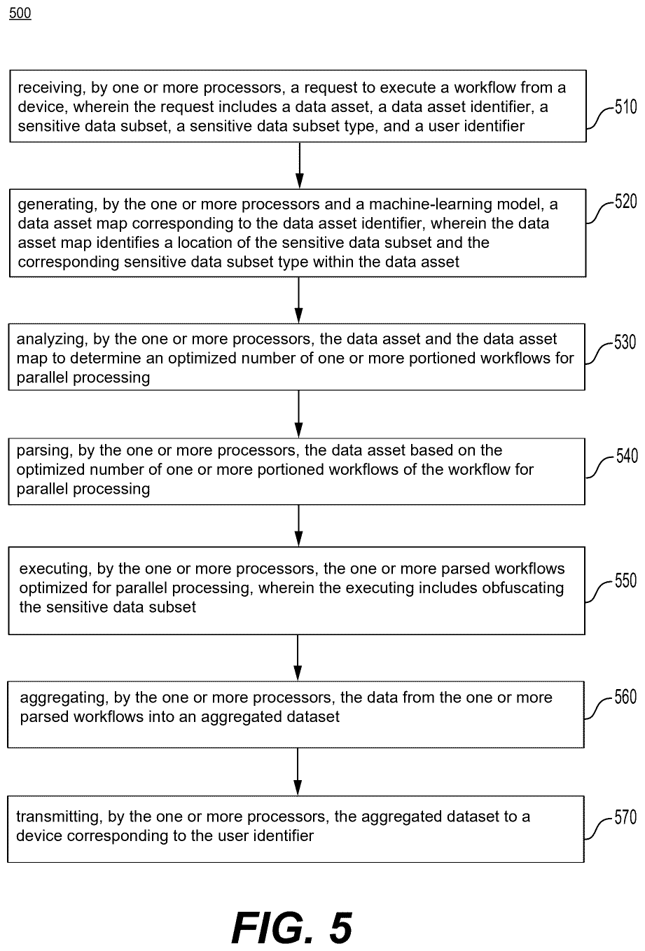

FIG. 5 depicts a flowchart of an exemplary method 500 for test data management by optimizing modification of test data based on one or more workflows, according to one or more embodiments. Method 500 may be performed by one or more processors of a server that is in communication with one or more user devices and other external system(s) via a network. However, it should be noted that method 00 may be performed by any one or more of the server, one or more user devices, or other external systems. In some embodiments, each service described below (e.g., capture service, modify service, provision service) and/or the sub-components of the services may be containerized. The containerized services may be individually executed anywhere they are assigned in a cloud based environment. This may allow the method 500 to more efficiently use computer resources.

The method may include receiving, by one or more processors (e.g., processor 105B, processor 115D), a request to execute a workflow from a device (Step 510). The workflow may define a process for modifying a data asset such that the data asset may be used as test data for the development and testing of an application. The request may include data specifying the function and execution of the workflow. For example, the request may include a data asset, a data asset identifier, a sensitive data subset, a sensitive data subset type, and/or a user identifier. The workflow may define how a data asset should be modified for use in testing applications. Applications may use real-world test data that should be obfuscated or otherwise modified to prevent the exposure of sensitive data. For example, the data asset may include personally identifiable information (PII), sensitive personal information (SPI), personal health information (PHI), and/or similar types of sensitive data.

In some embodiments, the sensitive data may include customer data collected by an organization. For example, the data asset may include the date(s) of birth (DOBs), social security number(s) (SSN), vehicle identification number(s) (VINs), driver's license number(s) (DLNs), and/or other customer data that may be collected during an organization's operations. This data may be integral in the development, updating, and testing of applications of an organization. Application development, updating, and testing may be hosted in external environments and/or cloud-computing platforms external to the organization. As such, the use of this data with sensitive information may pose a security risk. To increase data security, the sensitive data within the data asset may be modified (e.g., obfuscated, de-identified, scrubbed) to prevent exposure of sensitive data in the event of a data breach and/or during development, updating, and/or testing of an application.

In some embodiments, the method may further include receiving, by the one or more processors, a prompt comprising the workflow defining a process for modifying the data asset; storing, by the one or more processors, the workflow for execution; and scheduling, by the one or more processors, the execution of the workflow. For example, the prompt defining one or more workflows by identifying a data asset and the modification of the data using the capture, modify, and/or provision service(s) may be received at a first time. The system may store the prompt for execution at a later date. For example, an application development and/or testing team may preemptively define a workflow for modifying a data asset which still has data being collected. The sensitive data type and modification may already be known, but the dataset may not be complete. Therefore, the workflow may be preemptively defined in the prompt and saved for execution when the data collection in the data asset is complete. The request for execution of the one or more workflows identified in the prompt may be received at a second time. In some embodiments, the first time and the second time be simultaneous. Additionally or alternatively, the second time may be received minutes, hours, days, weeks, months, and/or years after the first time. As a result, the data asset may have changed in contents and/or location. Therefore, the request may update the data asset identifier and/or location of the data asset previously included in the prompt.

In some embodiments, the workflow may be defined by a JSON prompt from a device (e.g., user device(s) 105). Additionally or alternatively, the prompt and/or request may be generated using a user application programming interface. The API may allow a user device to define a workflow for modifying data. For example, the workflow may include identifying the data asset, identify one or more sensitive data types, and/or identify null values to replace the sensitive data. In some embodiments, the workflow may define a target destination and/or target testing environment to transmit the modified data asset. In some embodiments, the target destination(s) may include one or more data stores (e.g., database(s) 115A, data asset lakes, data stream(s)) and/or one or more user devices associated with the user identifier (e.g., user device(s) 105).

The method may include generating, by the one or more processors and a machine-learning model, a data asset map corresponding to the data asset identifier (Step 520). The data asset map may identify a location of the sensitive data subset and the corresponding sensitive data subset type within the data asset.

One or more machine-learning models and/or generative Artificial Intelligence (“AI”) models may analyze data and generate data asset maps and/or an optimized number of portioned workflows. The method may include inputting, the data asset and sensitive data subset type into the machine-learning model. The machine-learning model may be configured to determine the location of the sensitive data subset within the data asset, where the determining may be based on the sensitive data subset type identified in the request.

In some embodiments, the machine-learning model may have been previously trained to analyze a data asset to generate a data asset map. The generated data asset map may include a location of a subset of sensitive data based on a data asset identifier, a data asset location, and/or one or more sensitive data types.

For example, in some embodiments, the method may further include inputting, by the one or more processors, unstructured data of the data asset into the machine-learning model. The machine-learning model may be configured to process the unstructured data and create the data asset map. The method may further include, in response to the inputting, receiving, by the one or more processors, the data asset map from the machine-learning model. The data asset map may identify the location of the sensitive data within the data asset. This may allow the one or more processors to efficiently modify the data asset according to the one or more workflows.

In some embodiments, the system may use source code (e.g., application and infrastructure source code from the application the modified data will be used in) for generating the data asset map. For example, the source code (or a portion of the source code) may be used as an input in the machine-learning model to generate the data asset map. The use of source code may allow the system to better identify sensitive data types in the data asset by understanding the use of the data in the application.

In some embodiments, the method may further include, retrieving, by the one or more processors, the data asset from a data store and extracting, by the one or more processors, a portion of data of the data asset to generate the map of the sensitive data.

The method may include analyzing, by the one or more processors, the data asset and the data asset map to determine an optimized number of one or more portioned workflows for parallel processing (Step 530). In some embodiments, the machine-learning model may additionally or alternatively configured to use the data asset and/or the data asset map to determine an optimized number of one or more portioned workflows for parallel processing. For example, the data asset and/or data asset map may be input into a machine-learning model configured to determine an optimized number of one or more portioned workflows for parallel processing.

The machine-learning model may provide a recommended optimized number of one or more portioned workflows. The system may process the one or more portioned workflows based on the available computer resources at the time of execution of the one or more workflows. This may increase both the efficiency of executing the one or more workflows. Additionally or alternatively, the computer resources may be used more efficiently. In some embodiments, the machine-learning model may have been previously trained to determine an optimized number of portioned workflows based on a data asset and data asset map.

In some embodiments, the optimized number of portioned workflows may depend on the size of the data asset. For example, a workflow may define a modification for a large data asset. The large data asset may comprise a data asset map that indicates a small number of modifications that should be performed based on the data asset map, despite the amount of data in the data asset. In some embodiments, the machine-learning model may determine that the corresponding workflow should not be portioned for efficient processing.

Additionally or alternatively, a workflow may define a modification for a large data asset, where the large data asset may include a data asset map that indicates a large number of modifications should be performed. The machine-learning model may determine that the corresponding workflow should be portioned into one or more portioned workflows for efficient processing based on the available computer resources. Similarly, in some embodiments, the data asset may have a small size, with a large number or small number of modifications based on the data asset map. The machine-learning model may be configured to determine an optimized number of one or more portioned workflows based on the data asset, data asset map, size of the data asset and/or computer resources at the time of execution of the one or more workflows.

In some embodiments, the method may further include, storing, by the one or more processors, a raw data cache of the data asset in a data store prior to executing the workflow. The raw data cache may store a copy of the data asset to prevent the original data asset from being changed or otherwise damaged during modification. In some embodiments, a data asset may be identified in one or more workflows from one or more user devices. The modification defined in each workflow may be different. Therefore, the modification should be performed on a copy of the raw data to prevent errors and/or increased processing in other workflows that may use the same data asset.

The method may include parsing, by the one or more processors, the data asset based on the optimized number of one or more portioned workflows of the workflow for parallel processing (Step 540). The one or more portioned workflows may include sub-workflows, where the system may parse and portion the data asset into one or more smaller datasets. The one or more portioned workflows may execute the same modification defined in the workflow for each of the parsed and portioned datasets. In some embodiments, the one or more portioned workflows may be processed in parallel to increase the efficiency of executing the workflow and the use of computer resources. In some embodiments, according to the recommendation provided by the machine-learning model, the data asset may be parsed and portioned evenly (e.g., 20 file increments) and/or the sizes of the portions of the data asset may be uneven, but have similar processing times for parallel processing.

The method may include executing, by the one or more processors, the one or more parsed workflows optimized for parallel processing (Step 550). The executing may include obfuscating the sensitive data subset. The execution of the one or more portioned workflow may obfuscate the sensitive data and replace the instances of the sensitive data with a null value. For example, the one or more processors may generate a null value that is an appropriate replacement for the sensitive data. Additionally or alternatively, the one or more workflows may indicate specific null values that correspond to individual sensitive data types. For example, a date of birth may be replaced with text and/or numbers that the target destination application recognizes as a null value. The data asset map may indicate the locations of the PII within the data asset. During execution, the one or more processors may use the data asset map and one or more workflows to modify the data asset accordingly. In some embodiments, the source code used to generate the data asset map may also be used to generate null values. The system may use the source code to determine the most realistic null values in order to provide realistic development and testing data for the application environment.

The method may include aggregating, by the one or more processors, the data from the one or more parsed workflows in to an aggregated dataset (Step 560). In some embodiments, the modified data of the one or more portioned workflows may be stored in a data store (e.g., database(s) 115A). When each of the one or more portioned workflows has been executed, the modified data may be aggregated into a single dataset (e.g., an aggregated dataset).

The method may include transmitting, by the one or more processors, the aggregated dataset to a device corresponding to the user identifier (Step 570). In some embodiments, the method may further include, storing, by the one or more processors, a working copy of the aggregated dataset in a temporary data store. For example the working copy of the aggregated dataset may be transmitted to a target destination. The target destination(s) may include storage devices (e.g., a database), a user device corresponding to the user identifier in the request, and/or directly to a testing environment the device.

In response to storing and transmitting the working copy of the aggregated dataset, storing, by the one or more processors, a golden copy of the aggregated dataset in a data store for long term storage. For example, the one or more processors may store a golden copy of the aggregated dataset in a data store (e.g., database(s) 115A) (Golden Copy Data Cache 273). The system may store the golden copy in long term or permanent storage. This may create a back-up for the data after being transmitted to the target destination(s). The golden copy is preserved if the data is corrupted, damaged, and/or needs to be verified against a golden copy during use in the testing environment. Additionally, the system may execute the one or more workflows repeatedly as data may be added to the data asset and/or the test environment iterates through the testing process.

The storage of a golden copy of the aggregated dataset may allow the one or more processors to efficiently execute repetitions of the one or more workflows. For example, data may have been added to the data asset after the initial execution of the workflow. The golden copy of the modified data stored at the golden copy data cache 273, the raw data stored at the raw data cache 271, and/or the data asset may be compared to each other to determine that only a subset of the data asset has not been modified. The one or more processors may perform method 500 on the unmodified portions of the data asset according to the one or more workflows.

Although FIG. 5 shows example blocks of exemplary method 500, in some implementations, the exemplary process 500 may include additional blocks, fewer blocks, different blocks, or differently arranged blocks than those depicted in FIG. 5. Additionally, or alternatively, two or more of the blocks of the exemplary method 500 may be performed in parallel.

### Exemplary Device

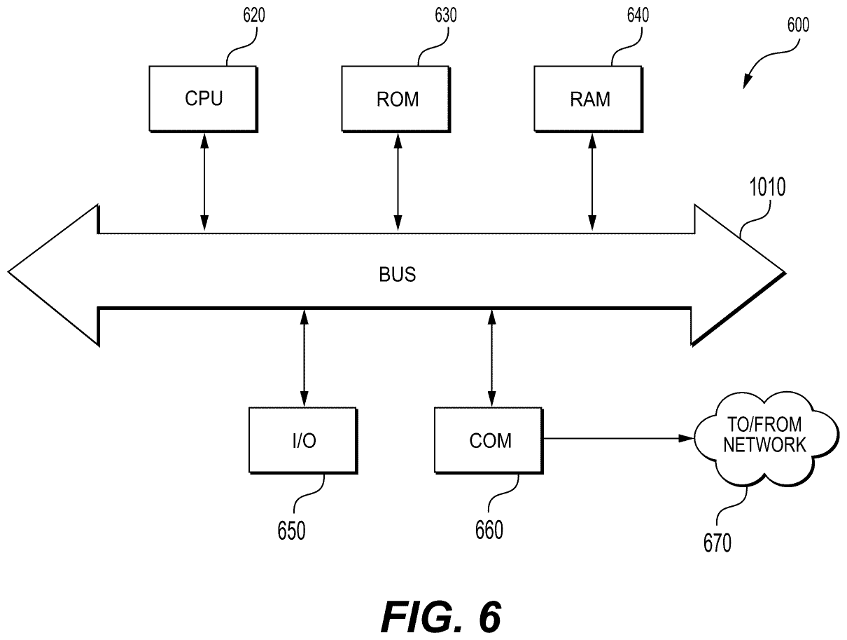

FIG. 6 is a simplified functional block diagram of a computer 600 that may be configured as a device for executing the methods and processes of FIGS. 2-5, according to exemplary embodiments of the present disclosure. For example, device 600 may include a central processing unit (CPU) 620. CPU 620 may be any type of processor device including, for example, any type of special purpose or a general-purpose microprocessor device. As will be appreciated by persons skilled in the relevant art, CPU 620 also may be a single processor in a multi-core/multiprocessor system, such system operating alone, or in a cluster of computing devices operating in a cluster or server farm. CPU 620 may be connected to a data communication infrastructure 610, for example, a bus, message queue, network, or multi-core message-passing scheme.

Device 600 also may include a main memory 640, for example, random access memory (RAM), and also may include a secondary memory 630. Secondary memory 630, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 630 may include other similar means for allowing computer programs or other instructions to be loaded into device 600. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 600.

Device 600 also may include a communications interface (“COM”) 660. Communications interface 660 allows software and data to be transferred between device 600 and external devices. Communications interface 660 may include a modem, a network interface (such as an Ethernet card), a communications port, a PCMCIA slot and card, or the like. Software and data transferred via communications interface 660 may be in the form of signals, which may be electronic, electromagnetic, optical, or other signals capable of being received by communications interface 660. These signals may be provided to communications interface 660 via a communications path of device 600, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 600 also may include input and output ports 650 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

In this disclosure, the term “based on” means “based at least in part on. ” The singular forms “a,” “an,” and “the” include plural referents unless the context dictates otherwise. The term “exemplary” is used in the sense of “example” rather than “ideal. ” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model/system is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), decision tree, gradient boosting in a decision tree, deep learning, and/or a deep neural network. Supervised and/or unsupervised training may be employed. For example, supervised learning may include providing training data and classifications corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for test data management, the computer-implemented method for test data management comprising:
receiving, by one or more processors, a request to execute a workflow from a device, wherein the request includes a data asset identifier corresponding to a data asset, a sensitive data subset, a sensitive data subset type, and a user identifier;
generating, by the one or more processors and a machine-learning model, a data asset map corresponding to the data asset identifier, wherein the data asset map identifies a location of the sensitive data subset and the corresponding sensitive data subset type within the data asset;
analyzing, by the one or more processors, the data asset and the data asset map to determine an optimized number of one or more portioned workflows for parallel processing;
parsing, by the one or more processors, the data asset based on the optimized number of one or more portioned workflows of the workflow for parallel processing;
executing, by the one or more processors, the one or more parsed workflows optimized for parallel processing, wherein the executing includes obfuscating the sensitive data subset;
aggregating, by the one or more processors, the data from the one or more parsed workflows into an aggregated dataset; and
transmitting, by the one or more processors, the aggregated dataset to a device corresponding to the user identifier.

2. The computer-implemented method of claim 1, the computer-implemented method further comprising:
receiving, by the one or more processors, a prompt that includes the workflow that defines a process for modifying the data asset;
storing, by the one or more processors, the workflow for execution; and
scheduling, by the one or more processors, the execution of the workflow.

3. The computer-implemented method of claim 1, wherein generating further comprises:
inputting, by the one or more processors, unstructured data of the data asset into the machine-learning model, wherein the machine-learning model is configured to process the unstructured data and create the data asset map; and
in response to the inputting, receiving, by the one or more processors, the data asset map from the machine-learning model.

4. The computer-implemented method of claim 1, the computer-implemented method further comprising:
retrieving, by the one or more processors, the data asset from a data store; and
extracting, by the one or more processors, a portion of data of the data asset to generate the map of the sensitive data.

5. The computer-implemented method of claim 1, wherein the workflow is defined by a JSON prompt.

6. The computer-implemented method of claim 1, the computer-implemented method further comprising:
storing, by the one or more processors, a raw data cache of the data asset in a data store prior to executing the workflow.

7. The computer-implemented method of claim 1, the computer-implemented method further comprising:
storing, by the one or more processors, a working copy of the aggregated dataset in a temporary data store, wherein the working copy of the aggregated dataset is transmitted to the device corresponding to the user identifier in the request; and
in response to storing and transmitting the working copy of the aggregated dataset, storing, by the one or more processors, a golden copy of the aggregated dataset in a data store for long term storage.

8. The computer-implemented method of claim 1, wherein the sensitive data includes at least one of: Personally Identifiable Information (PII), Sensitive Personal Information (SPI), and Personal Health Information (HPI).

9. The computer-implemented method of claim 1, wherein a size of the data is used in analyzing the data asset and the data asset map to determine an optimized number of one or more portioned workflows for parallel processing.

10. A computer system for test data management, the computer system comprising:
a memory having processor-readable instructions stored therein;
one or more processors configured to access the memory and execute the processor-readable instructions, which when executed by the one or more processors configures the one or more processors to perform a plurality of functions, including functions for:
receiving, by one or more processors, a request to execute a workflow from a device, wherein the request includes a data asset, a data asset identifier, a sensitive data subset, a sensitive data subset type, and a user identifier;
generating, by the one or more processors and a machine-learning model, a data asset map corresponding to the data asset identifier, wherein the data asset map identifies a location of the sensitive data subset and the corresponding sensitive data subset type within the data asset;
analyzing, by the one or more processors, the data asset and the data asset map to determine an optimized number of one or more portioned workflows for parallel processing;
parsing, by the one or more processors, the data asset based on the optimized number of one or more portioned workflows of the workflow for parallel processing;
executing, by the one or more processors, the one or more parsed workflows optimized for parallel processing, wherein the executing includes obfuscating the sensitive data subset;
aggregating, by the one or more processors, the data from the one or more parsed workflows into an aggregated dataset; and
transmitting, by the one or more processors, the aggregated dataset to a device corresponding to the user identifier.

11. The computer system of claim 10, the computer system further comprising:
receiving, by one or more processors, a prompt that includes the workflow that defines a process for modifying the data asset;
storing, by the one or more processors, the workflow for execution; and
scheduling, by the one or more processors, the execution of the workflow.

12. The computer system of claim 10, wherein the generating further comprises:
inputting, by the one or more processors, unstructured data of the data asset into the machine-learning model, wherein the machine-learning model is configured to process the unstructured data and create the data asset map; and
in response to the inputting, receiving, by the one or more processors, the data asset map from the machine-learning model.

13. The computer system of claim 10, the computer system further comprising:
retrieving, by the one or more processors, the data asset from a data store; and
extracting, by the one or more processors, a portion of data of the data asset to generate the map of the sensitive data.

14. The computer system of claim 10, wherein the workflow is defined by a JSON prompt.

15. The computer system of claim 10, the computer system further comprising:
storing, by the one or more processors, a raw data cache of the data asset in a data store prior to executing the workflow.

16. The computer system of claim 15, the computer system further comprising:
storing, by the one or more processors, a working copy of the aggregated dataset in a temporary data store, wherein the working copy of the aggregated dataset is transmitted to the device corresponding to the user identifier in the request; and
in response to storing and transmitting the working copy of the aggregated dataset, storing, by the one or more processors, a golden copy of the aggregated dataset in a data store for long term storage.

17. The computer system of claim 10, wherein the sensitive data includes at least one of: Personally Identifiable Information (PII), Sensitive Personal Information (SPI), and Personal Health Information (PHI).

18. The computer system of claim 10, wherein a size of the data is used in analyzing the data asset and the data asset map to determine an optimized number of one or more portioned workflows for parallel processing.

19. A non-transitory computer-readable medium containing instructions for test data management, the instructions comprising:
receiving, by one or more processors, a request to execute a workflow from a device, wherein the request includes a data asset, a data asset identifier, a sensitive data subset, a sensitive data subset type, and a user identifier;
generating, by the one or more processors and a machine-learning model, a data asset map corresponding to the data asset identifier, wherein the data asset map identifies a location of the sensitive data subset and the corresponding sensitive data subset type within the data asset;
analyzing, by the one or more processors, the data asset and the data asset map to determine an optimized number of one or more portioned workflows for parallel processing;
parsing, by the one or more processors, the data asset based on the optimized number of one or more portioned workflows of the workflow for parallel processing;
executing, by the one or more processors, the one or more parsed workflows optimized for parallel processing, wherein the executing includes obfuscating the sensitive data subset;
aggregating, by the one or more processors, the data from the one or more parsed workflows into an aggregated dataset; and
transmitting, by the one or more processors, the aggregated dataset to a device corresponding to the user identifier.

20. The non-transitory computer-readable medium of claim 19, the non-transitory computer-readable medium further comprising:
receiving, by one or more processors, a prompt that includes the workflow that defines a process for modifying the data asset;
storing, by the one or more processors, the workflow for execution; and
scheduling, by the one or more processors, the execution of the workflow.
